(19) United States
(12) Patent Application Publication
(10) Pub. No.: US 2025/0056306 A1
(43) Pub. Date: Feb. 13, 2025

(54) QOS SUPPORT IN UE-TO-UE RELAY

(71) Applicant: Nokia Technologies Oy, Espoo (FI)

(72) Inventors: Vinh VAN PHAN, Oulu (FI); Ling YU, Kauniainen (FI); Saubhagya BALIARSINGH, Bengaluru (IN); Faranaz SABOURI-SICHANI, Aalborg (DK); Apostolos KOUSARIDAS, Munich (DE); Sayed Ali MARANDI, Aalborg (DK)

(21) Appl. No.: 18/791,939

(22) Filed: Aug. 1, 2024

(30) Foreign Application Priority Data
Aug. 9, 2023 (IN) 202341053466

(51) Int. Cl. H04W 28/02; H04W 88/04

(52) U.S. Cl. CPC H04W 28/0268; H04W 88/04

(57) ABSTRACT

Quality of service (QOS) support in UE-to-UE (U2U) relay. In an example method, a terminal device determines a quality of service (QoS) split configuration for an end-to-end (E2E) radio bearer (RB) in U2U relay communication, and the QoS split configuration includes at least a first set of ranges for a first portion of a QoS parameter configured for the E2E RB. The terminal device transmits the QoS split configuration to a second terminal device, the second terminal device is a transmitting device in the ingress hop of the first terminal device. In this way, a configuration and adaptation of packet delay budget (PDB) split in U2U relay may be enabled and facilitated.

### FIELD

Example embodiments of the present disclosure generally relate to the field of communications, and in particular, to devices, methods, apparatuses and a computer readable storage medium for quality of service (QOS) support in UE-to-UE (U2U) relay.

### BACKGROUND

For Layer 2 (L2) UE-to-UE Relay architecture, the protocol stacks are similar to L2 UE-to-Network Relay, while the termination points of L2 U2U relay are two Remote UE devices. The 3GPP R2-2306843 has recited Stage-2 description of U2U relay, wherein the Sidelink Relay Adaptation Protocol (SRAP) sublayer is placed above the Radio Link Control (RLC) sublayer for both Control Plane and User Plane at both PC5 interfaces. The feature of L2 UE-to-UE relay is that L2 relay function is performed below Packet Data Convergence Protocol (PDCP) and the two endpoints of the PDCP link are the source UE and the target UE. There are still some open problems in such UE-to-UE (U2U) relay communication that need to be studied in the future.

### SUMMARY

In general, example embodiments of the present disclosure provide a solution for enabling and facilitating configuration and adaptation of a QoS parameter split such as packet delay budget (PDB) split in U2U relay. The example embodiments of the present disclosure may be based on the current agreements in 3GPP for the case of 2-hop U2U relay that the U2U relay UE determines and configures per-hop PDBs for the first hop and second hop. In the context of this disclosure, a ‘hop’ may refer to a direct sidelink connection between two neighboring UEs in U2U relay communication, where a UE may be a remote end UE or a U2U relay UE. The example embodiments of the present disclosure are also applicable for multi-hop U2U relay following hop-by-hop control principle. It is noted that 2-hop U2U relay via a single U2U relay UE is also referred to as single-hop U2U relay, counting the number of relayed hops.

In a first aspect, there is provided a first terminal device. The first terminal device comprises at least one processor and at least one memory storing instructions that, when executed by the at least one processor, cause the first terminal device at least to: determine a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device; and transmit the QoS split configuration to a second terminal device, the second terminal device is a transmitting device in the ingress hop of the first terminal device.

In a second aspect, there is provided a second terminal device. The second terminal device comprises at least one processor and at least one memory storing instructions that, when executed by the at least one processor, cause the second terminal device at least to: receive, from a first terminal device, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of the second terminal device; and determine a first indication of a range among the first set of ranges for the first portion of the QoS parameter.

In a third aspect, there is provided a method. The method comprises determining, at a first terminal device, a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device; and transmitting the QoS split configuration to a second terminal device, the second terminal device is a transmitting device in the ingress hop of the first terminal device.

In a fourth aspect, there is provided a method. The method comprises receiving, at a second terminal device and from a first terminal device, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of the second terminal device; and determining a first indication of a range among the first set of ranges for the first portion of the QoS parameter.

In a fifth aspect, there is provided an apparatus. The apparatus comprises means for determining, at a first terminal device, a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device; and means for transmitting the QoS split configuration to a second terminal device, the second terminal device is a transmitting device in the ingress hop of the first terminal device.

In a sixth aspect, there is provided an apparatus. The apparatus comprises means for receiving, at a second terminal device and from a first terminal device, a quality of service (QoS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of the second terminal device; and means for determining a first indication of a range among the first set of ranges for the first portion of the QoS parameter.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a first terminal device. The first terminal device comprises determining circuitry configured to determine a quality of service (QOS) split configuration for an end-to-end (E2E) radio bearer (RB) in user equipment (UE)-to-UE relay communication, wherein a first terminal device is a relay in the UE-to-UE relay communication, and the QoS split configuration comprises at least a first set of ranges for a first portion of a QoS parameter configured for the E2E RB, the first portion is for an ingress hop of the first terminal device. The first terminal device comprises transmitting circuitry configured to transmit the QoS split configuration to a second terminal device, the second terminal device is a transmitting device in the ingress hop of the first terminal device.

In a tenth aspect, there is provided a second terminal device. The second terminal device comprises receiving circuitry configured to receive, from a first terminal device, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of the second terminal device. The second terminal device comprises determining circuitry configured to determine a first indication of a range among the first set of ranges for the first portion of the QoS parameter.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which example embodiments of the present disclosure can be implemented;

FIG. 1B illustrates an example of a user plane protocol stack for L2 UE-to-UE relay associated with some example embodiments of the present disclosure;

FIG. 1C illustrates an example of a control plane protocol stack for L2 UE-to-UE relay associated with some example embodiments of the present disclosure;

FIG. 1D illustrates an example of End-to-End QoS for 5G ProSe Layer-3 UE-to-UE Relay operation associated with some example embodiments of the present disclosure;

FIG. 2 illustrates a process flow of method according to some embodiments of the present disclosure;

FIG. 3 illustrates an example of PDB split configuration 300 in accordance with some example embodiments of the present disclosure;

FIG. 4 illustrates example interactions between a transmitting end UE, U2U relay UE and receiving end UE for QoS split configuration and adjustment in accordance with some example embodiments of the present disclosure;

FIG. 5 illustrates a flowchart of a method performed by a terminal device in accordance with some example embodiments of the present disclosure;

FIG. 6 illustrates a flowchart of a method performed by a terminal device in accordance with some example embodiments of the present disclosure;

FIG. 7 illustrates a simplified block diagram of a device 700 that is suitable for implementing some example embodiments of the present disclosure; and

FIG. 8 illustrates a block diagram of an example of a computer readable medium 800 in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuits (such as i analog and/or digital circuits) and
(b) combinations of hardware circuits and software, such as (as applicable):
   (i) a combination of analog and/or digital hardware circuit(s) with software (e.g., firmware); and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “cellular network” refers to a network operating in accordance with any suitable radio access technology defined by standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT), and so on. Furthermore, the communications between a terminal device and a network device of a cellular network may be performed according to any suitable communication protocols, including, but not limited to, the fourth generation (4G), 4.5G, the fifth generation (5G) communication protocols, and/or any other protocols cither currently known or to be developed in the future. Embodiments of the present disclosure may be applied in various cellular networks. Given the rapid development in communications, there will of course also be future type communication technologies and systems with which the present disclosure may be embodied. It should not be seen as limiting the scope of the present disclosure to only the aforementioned system.

As used herein, the term “network device” refers to any device in a cellular network via which a terminal device accesses a data network and receives services exposed by other network devices of the cellular network. In some examples, a network device may comprise or implement a network function of a 5th generation communication system (5GS) (e.g., a core network) of a cellular network. In some examples, the network devices may be located at the RAN of the 5GS. The network device may be part of a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico node, and so forth, depending on the applied terminology and technology. A gNB may include a centralized unit CU and one or more distributed DUs. Femto and Pico nodes are small base stations with a small coverage area.

The term “terminal device” refers to a device of a communication system of a cellular network, such as a 5th generation communication system (5GS) that may be capable of wireless (e.g., radio) communication with a NR-RAN of the 5GS over Uu interface or other terminal device(s) over sidelink (SL), also known as PC5 interface. By way of example rather than limitation, a terminal device may also be referred to as a wireless communication device, user equipment (UE), a Subscriber Station (SS), a Portable Subscriber Station, a Mobile Station (MS), or an Access Terminal (AT). Examples of a terminal device include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably. It is noted that the term “quality of service (QOS) split” may refer to, among other QoS parameters, a split of end-to-end (E2E) packet delay budget (PDB) configured for an E2E radio bearer (RB) for per-hop PDB, e.g., for the first hop and the second hop in 2-hop (or, i.e., single-hop) U2U relay communication or for individual hops in multi-hop U2U relay communication.

A U2U relay UE, as the receiving UE of the first hop, may have certain knowledge about sidelink (SL) condition and transmission delay of individual packets on the first hop based on, e.g., SL Hybrid Automatic Repeat-reQuest (HARQ) performance. However, the U2U relay UE may not have knowledge about scheduling delay on the first hop, because the transmitting end UE may have to delay SL transmission to the U2U relay UE due to, such as having to prioritize SL or Uu transmission or reception for other SL or Uu connection(s) the transmitting end UE may have; or experiencing SL congestion on the first hop affecting SL resource allocation for its transmission in UE autonomous resource allocation mode, referred to as mode 2 in NR SL. The transmitting end UE and U2U relay UE also need to adapt data transmission to conditions of the first hop and second hop to meet E2E QoS requirements, including E2E PDB, for individual PDCP packets of corresponding E2E RB to minimize packet dropping. In this regard, a dynamic QoS split is needed. This in turn, may require frequent exchange of SL conditions on the first hop and second hop between the transmitting end UE and U2U relay UE and frequent reconfiguration of QoS split from the U2U relay UE to the transmitting end UE. Furthermore, the QoS split for U2U relay needs to consider support of multi-hop U2U relay and therefore needs to be simple and scalable with the number of hops.

In view of the above, example embodiments of the present disclosure provide a solution for QoS support in U2U relay. Especially, in the example embodiments of the present disclosure, a first terminal device which is a U2U relay UE may determine a QoS split configuration for an E2E RB in U2U relay communication and transmit the QoS split configuration to a second terminal device which may be a transmitting end UE or another U2U relay UE. In this way, the U2U relay UE may be enabled and facilitated to determine and configure the QoS split, focusing on split of E2E PDB into per-hop PDBs for the first hop and second hop in the case of 2-hop U2U relay as well as for the individual hops in the case of multi-hop U2U relay.

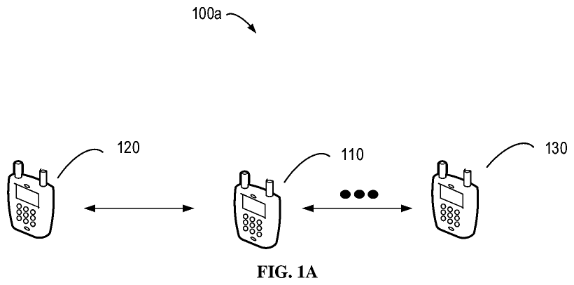

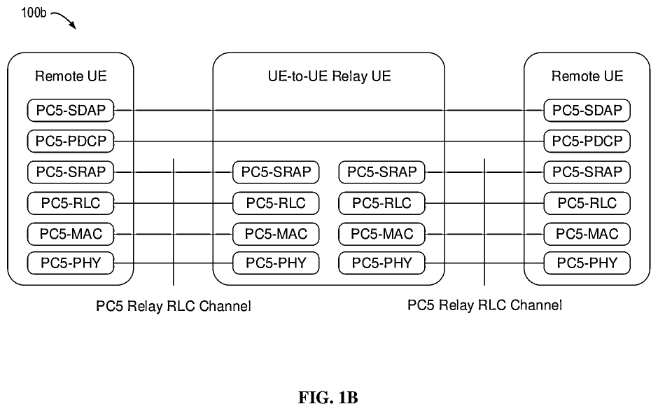

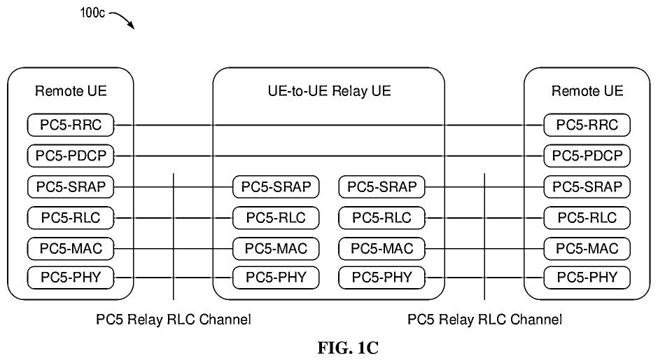

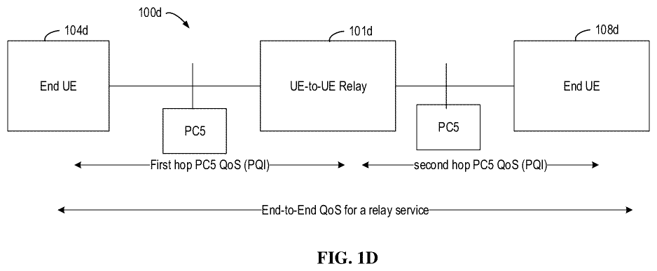

FIG. 1A illustrates an example of a network environment 100a in which example embodiments of the present disclosure can be implemented. The environment 100a may be a part of a communication network and comprise a plurality of terminal devices, such as a first terminal device 110, a second terminal device 120, and a third terminal device 130. As an example, the first terminal device 110 may be implemented as an UE-to-UE relay UE device, the second terminal device 120 may be implemented as a transmitting end UE device, and the third terminal device 130 may be implemented as a receiving end UE device in the case of 2-hop U2U relay or another UE-to-UE relay UE device in the case of multi-hop relay.

FIG. 1B illustrates an example 100b of a user plane protocol stack for L2 UE-to-UE relay associated with some example embodiments of the present disclosure. FIG. 1C illustrates an example 100c of a control plane protocol stack for L2 UE-to-UE relay associated with some example embodiments of the present disclosure. As illustrated in 100b-100c, the Sidelink Relay Adaptation Protocol (SRAP) sublayer is placed above the Radio Link Control (RLC) sublayer for both Control Plane and User Plane at both PC5 interfaces. The sidelink Service Data Adaptation Protocol (SDAP), Packet Data Convergence Protocol (PDCP), and Radio Resource Control (RRC) are terminated between two L2 U2U Remote UEs, while SRAP, RLC, MAC, and PHY are terminated in each PC5 link for respective hop, wherein each link is between L2 U2U Remote UE and the L2 U2U Relay UE.

The SRAP sublayer existing in L2 U2U Remote UE and L2 U2U Relay UE may perform bearer mapping to map end-to-end SL bearer (SRB, DRB) of L2 U2U Remote UE into PC5 U2U Relay RLC Channel. The PC5 SRAP sublayer existing in L2 U2U Relay UE and L2 U2U Remote UE supports L2 U2U Remote UE identification for the sidelink traffic from the source L2 U2U Remote UE to the destination L2 U2U Remote UE.

The identification of L2 U2U Remote UE end-to-end bearer and a Remote UE ID included in the SRAP header may support to correlate the received packets with the RLC Channel of the L2 U2U Relay UE and correlate the transmit packets for the PDCP entity associated with the end-to-end radio bearer and the destination L2 U2U Remote UE ID. It may also support to correlate the received packets for the PDCP entity associated with the end-to-end radio bearer and the source L2 U2U Remote UE ID.

The PC5 SRAP sublayer at L2 U2U Remote UE may support identification of the destination L2 U2U Remote UE. An ID being able to be mapped to the destination L2 U2U Remote UE is included in the SRAP header of the traffic from the source L2 U2U Remote UE to the L2 U2U Relay. The PC5 SRAP sublayer at L2 U2U Relay UE supports identification of the source L2 U2U Remote UEs. An ID being able to be mapped to the source L2 U2U Remote UE is included in the SRAP header of the traffic from L2 U2U Relay UE to the destination L2 U2U Remote UE.

The SRAP sublayer at L2 U2U Relay UE can perform data multiplexing from multiple RLC channels of the different source L2 U2U Remote UE to the same RLC channel of the destination L2 U2U Remote UE for the different end-to-end bearers. The SRAP sublayer at L2 U2U Relay UE can perform data demultiplexing from the same RLC channel of the source L2 U2U Remote UE to the multiple RLC channel of the different destination L2 U2U Remote UE for the different end-to-end bearers. It is noted that in the context of this disclosure, the remote UE may be also referred to as End UE, source end UE, target end UE, transmitting end UE, or receiving end UE.

FIG. 1D illustrates an example 100d of End-to-End QoS for 5G ProSe Layer-3 UE-to-UE Relay operation associated with some example embodiments of the present disclosure. For a 5G ProSe Layer-3 End UE 104d connecting with another 5G ProSe Layer-3 End UE(s) 108d via 5G ProSe Layer-3 UE-to-UE Relay 101d, the QoS requirement of the relay traffic between the peer 5G ProSe Layer-3 End UE(s) may be satisfied by the corresponding QoS control for the PC5 link between source 5G ProSe Layer-3 End UE 104d and 5G ProSe Layer-3 UE-to-UE Relay 101d (i.e. first hop PC5 QoS control) and the QoS control for the PC5 link between 5G ProSe Layer-3 UE-to-UE Relay 101d and target 5G ProSe Layer-3 End UE 108d (i.e. second hop PC5 QoS control).

The first hop PC5 QoS and second hop PC5 QoS may be controlled with PC5 QoS rules and PC5 QoS parameters (e.g., PQI, GFBR, MFBR, PC5 LINK-AMBR). The end-to-end QoS is met only when the QoS requirements are properly translated and satisfied over the two hops, respectively. To achieve this, the source 5G ProSe Layer-3 End UE 104d initiates PC5 QoS Flows setup or modification during the Layer-2 link establishment or modification procedure, the source 5G ProSe Layer-3 End UE 104d provides the QoS Info to the 5G ProSe Layer-3 UE-to-UE Relay 101d. The received PC5 QoS parameters of the QOS Info (i.e. PQI and conditionally other parameters such as MFBR/GFBR, etc.) are interpreted as the end-to-end QoS requirements by the 5G ProSe Layer-3 UE-to-UE Relay 101d for the traffic transmission between source 5G ProSe Layer-3 End UE 104d and target 5G ProSe Layer-3 End UE 108d.

The 5G ProSc Layer-3 UE-to-UE Relay 101d, based on its implementation, decides the PQI for the first hop PC5 QoS control and the PQI for the second hop PC5 QoS control. The 5G ProSe Layer-3 UE-to-UE Relay 101d provides the QoS Info (including PQI value chosen by the 5G ProSe Layer-3 UE-to-UE Relay 101d for the second hop) to the target 5G ProSe Layer-3 End UE 108d. After accepted QoS Info of the second hop QoS from the target 5G ProSe Layer-3 End UE 108d is received, 5G ProSe Layer-3 UE-to-UE Relay 101d provides the QoS Info (including PQI value chosen by the 5G ProSe Layer-3 UE-to-UE Relay 101d for the first hop) to the source 5G ProSe Layer-3 End UE 104d with considering the received second hop QoS.

If the source 5G ProSe Layer-3 End UE 104d performs the Layer-2 link modification procedure to add new PC5 QoS Flow(s) or modify the existing PC5 QoS Flow(s) for IP traffic or Ethernet traffic over PC5 reference point, the source 5G ProSe Layer-3 End UE 104d may also provide the PC5 QoS Rule(s) for the PC5 QoS Flow(s) to be added or modified to the 5G ProSe Layer-3 UE-to-UE Relay 101d. The 5G ProSe Layer-3 UE-to-UE Relay 101d may generate the Packet Filters used over the second hop based on the received PC5 QoS Rule(s).

For a 5G ProSe Layer-2 End UE connecting with another 5G ProSe Layer-2 End UE via a 5G ProSe Layer-2 UE-to-UE Relay, the source 5G ProSe Layer-2 End UE and the target 5G ProSe Layer-2 End UE may negotiate the end-to-end QoS for the traffic transmission between the source 5G ProSe Layer-2 End UE and the target 5G ProSe Layer-2 End UE. Access stratum (AS) layer is responsible for QoS split in L2 U2U relay, and Relay UE is responsible for AS layer QoS split in L2 U2U relay.

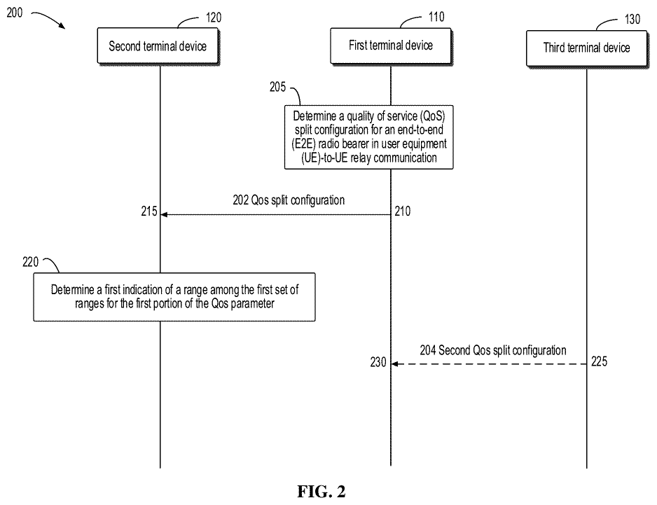

FIG. 2 illustrates a process flow of method according to some embodiments of the present disclosure. For the purpose of discussion, the process flow 200 will be described with reference to FIGS. 1A-1D. It would be appreciated that although the process flow 200 has been described referring to FIGS. 1A-1D, this process flow 200 may be likewise applied to other similar communication scenarios.

In the process flow 200, the first terminal device 110 may determine (205) a quality of service (Qos) split configuration for an end-to-end (E2E) radio bearer (RB) in user equipment (UE)-to-UE relay communication. In the context of this disclosure, the first terminal device 110 may be a relay in the UE-to-UE relay communication. The QoS split configuration determined by the first terminal device 110 may comprise at least a first set of ranges for a first portion of a QoS parameter configured for the E2E RB, and the first portion is for an ingress hop of the first terminal device 110. The QoS parameter may be divided into per-hop portions. The QoS parameter may be packet delay budget (PDB) configured for the E2E RB for example.

After determining the QoS split configuration, the first terminal device 110 may transmit (210) the QoS split configuration to a second terminal device 120, and the second terminal device 120 may be a transmitting device in the ingress hop of the first terminal device 110.

In some embodiments, the first terminal device 110 may receive a first indication of a range among the first set of ranges for the first portion of the QoS parameter from the second terminal device 120. Alternatively, or additionally, the first indication of the range among the first set of ranges may comprise at least one of an index of the range or a measurement of the first portion of the QoS parameter within the range.

The first terminal device 110 may receive the first indication of the range among the first set of ranges from the second terminal device 120 via a sidelink (SL) medium access control (MAC) control element (CE). In some embodiments, the first terminal device 110 may adjust a second portion of the QoS parameter for an egress hop of the first terminal device 110 based on the first indication of the range among the first set of ranges received from the second terminal device 120.

In some embodiments, the first terminal device 110 may obtain information indicative of the number of hop(s) of the UE-to-UE relay communication during or after an establishment procedure of the UE-to-UE relay communication. The first terminal device 110 then may determine the first portion of the QoS parameter for the ingress hop of the first terminal device 110 to be included in the QoS split configuration based on the number of hop(s).

In some embodiments, the UE-to-UE relay communication may be a two-hop relay communication, and in such a scenario, the first terminal device 110 may determine a second QoS split configuration for the E2E RB in the UE-to-UE relay communication. The second QoS split configuration may comprise at least a second set of ranges for the second portion of the QoS parameter for the egress hop of the first terminal device 110.

In some embodiments, the UE-to-UE relay communication may be a multi-hop relay communication, and in such a scenario, the first terminal device 110 may receive (230) a second QoS split configuration 204 for the E2E RB in the UE-to-UE relay communication transmitted (225) from a third terminal device 130. The third terminal device 130 may be a relay in the UE-to-UE relay communication and may be a receiving device in the egress hop of the first terminal device 110, and the second QoS split configuration 204 may comprise at least a second set of ranges for the second portion of the QoS parameter for the egress hop of the first terminal device 110.

Alternatively, or additionally, among the second set of ranges, the first terminal device 110 may determine a range for the second portion of the QoS parameter for the egress hop of the first terminal device 110. The first terminal device 110 may then transmit a second indication of the range among the second set of ranges to the third terminal device 130. In some embodiments, the first terminal device 110 may further transmit the second indication to the second terminal device.

In some embodiments, the first terminal device 110 may determine the range among the second set of ranges for the second portion of the QoS parameter based on the first indication received from the second terminal device 120. The first terminal device 110 may further transmit the second QoS split configuration 204 to the second terminal device. In some embodiments, the first terminal device 110 may select one of a plurality of QoS split configurations which are configured by a network device for the UE-to-UE relay communication.

On the second terminal device 120 side, the second terminal device 120 may receive (215) a quality of service (QOS) split configuration 202 for an end-to-end (E2E) radio bearer (RB) in user equipment (UE)-to-UE relay communication from the first terminal device 110. The QoS split configuration 202 received by second terminal device 120 may at least a first set of ranges for a first portion of a QoS parameter configured for the E2E RB, the first portion is for the egress hop of the second terminal device 120. The first terminal device 110 may be a relay in the UE-to-UE relay communication and is a receiving device in an egress hop of the second terminal device 120.

The second terminal device 120 may then determine (220) a first indication of a range among the first set of ranges for the first portion of the QoS parameter. In some embodiments, the second terminal device 120 may then transmit the first indication of the range to the first terminal device 110. The first indication of the range among the first set of ranges may comprise at least one of an index of the range or a measurement of the first portion of the QoS parameter within the range.

In some embodiments, the second terminal device 120 may transmit the first indication of the range among the first set of ranges to the first terminal device 110 via a sidelink (SL) medium access control (MAC) control element (CE). In some embodiments, the second terminal device 120 may receive a second QoS split configuration for the E2E RB in the UE-to-UE relay communication from the first terminal device 110, and the second QoS split configuration may comprise at least a second set of ranges for a second portion of the QoS parameter for an egress hop of the first terminal device 110.

In some embodiments, the second terminal device 120 may receive a second indication of a range among the second set of ranges for the second portion of the QoS parameter from the first terminal device 110. The second terminal device may then adjust the first portion of the QoS parameter for the egress hop of the second terminal device 120 based on the second indication. It is noted that in some embodiments, the first terminal device is a U2U relay UE, and the second terminal device 120 is an end UE in the UE-to-UE relay communication.

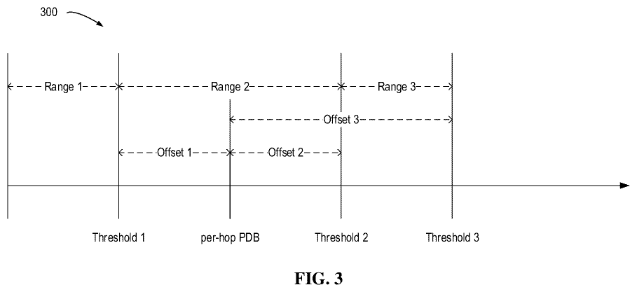

FIG. 3 illustrates an example of PDB split configuration 300 in accordance with some example embodiments of the present disclosure. In the context of this disclosure, the proposed configuration may be based on the agreements in 3GPP for the case of 2-hop U2U relay that the U2U relay UE determines and configures per-hop PDBs for the first hop and second hop as described above. The proposed configuration may be also applicable for multi-hop U2U relay following hop-by-hop control principle. The proposed adaptation of PDB split may be kept local between neighbouring transmitting UEs in U2U relay which may be the transmitting end UE and/or U2U relay UE(s).

As illustrated in FIG. 3, an U2U relay UE, such as the first terminal device 110, may configure the transmitting end UE (such as, the second terminal device 120) of the first hop with a split PDB for the first hop for an E2E RB. The split PDB comprising a set of specified PDB ranges which can be implemented by respective PDB threshold(s) and/or PDB offset(s). For example, the split PDB may comprise a configured per-hop PDB, range 1 corresponding to threshold 1, range 2 corresponding to threshold 2, and range 3 corresponding to threshold 3. The starting point of rang 1 may simply set to zero. The range 1 may be below the threshold 1, the range 2 may be between the threshold 1 and the threshold2, and the range 3 may be between the threshold 2 and the threshold 3.

In some embodiments, a packet delay that is monitored and measured at the transmitting UE for the E2E RB on its respective hop (and thus for per-hop PDB or portion of E2E PDB) is in the range 1, and it may be considered that the packet delay is significantly below expectation. In some embodiments, the packet delay is in the range 2, it is considered that the packet delay is in line with expectation. In some embodiments, the packet delay is in the range 3, it may be considered that the packet delay is significantly above the expectation. In some embodiments, the packet delay exceeds the threshold 3, a packet dropping may be considered.

Alternatively, or additionally, in some embodiments, the split PDB may comprise a configured per-hop PDB and offset 1, offset 2, and offset 3. In such a scenario, the threshold 1 may be the configured per-hop PDB minus the offset 1 (i.e., threshold 1=the configured per-hop PDB-offset 1), the threshold 2 may be the configured per-hop PDB plus the offset 2 (i.e. threshold 2=the configured per-hop PDB+offset 2), and the threshold 3 may be the configured per-hop PDB plus the offset 3 (i.e. threshold 3=the configured per-hop PDB+offset 3). In some embodiments, the U2U relay communication is a multi-hop relay communication, U2U relay UE may configure per-hop PDB split for its ingress hop.

In some embodiments, the U2U relay UE may also indicate the PDB split configuration for the second hop to the transmitting end UE. In some embodiments, the U2U relay communication is a multi-hop relay communication, the U2U relay UE may indicate or share the PDB split configurations of its ingress and egress hops with its neighbouring transmitting end UE(s) and/or U2U relay UE(s).

In some embodiments, when the packet delay on the respective hop, as measured by the transmitting UE, is on certain predefined range, such as range 1 or range 3, the U2U relay UE and the transmitting end UE, as transmitting UE on the respective hop (egress hop), may indicate the range of the packet delay on the respective hop to one another (or neighboring transmitting UEs in multi-hop U2U relay) via a sidelink (SL) medium access control (MAC) control element (CE). Moreover, the ranges may be indexed to facilitate the indication of a range among the specified ranges (i.e., indicating the ID of the range).

In some embodiments, the U2U relay UE and the transmitting end UE may adjust the per-hop PDB (the portion of E2E PDB) for the respective egress hop based on the received SL MAC CE of the PDB range indication from one to another. As an example, if the U2U relay UE receives the SL MAC CE from the transmitting end UE indicating that the expected packet delay on the first hop is in range 1, the U2U relay UE may adjust the per-hop PDB on the second hop to the configured per-hop PDB plus offset 1 (i.e., the configured per-hop PDB+offset 1).

On the other hand, if the U2U relay UE receives the MAC CE from the transmitting end UE indicating that the expected packet delay on the first hop is in range 3, the U2U relay UE may adjust the per-hop PDB on the second hop to the configured per-hop PDB minus the offset 2 (i.e., the configured per-hop PDB-offset 2). Accordingly, a simple QoS split configuration and hop-by-hop local adjustment may be implemented and it also support for a multi-hop U2U relay. As an example, the configured per-hop PDB may be set equal to E2E PDB divided by the number of hops. The offset 1 and the offset 2 may be set to half of the configured per-hop PDB, and the offset 3 may be set equal to the configured per-hop PDB.

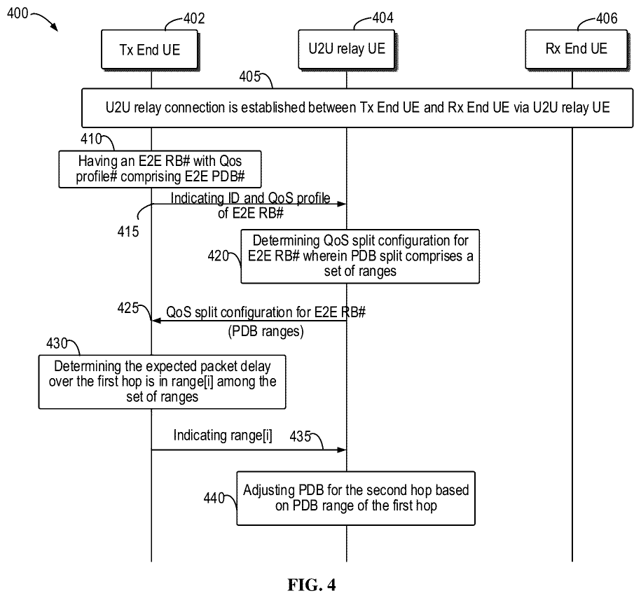

FIG. 4 illustrates example interactions between a transmitting end UE, U2U relay UE and receiving end UE for QoS split configuration and adjustment in accordance with some example embodiments of the present disclosure. It is noted that the process flow 400 can be deemed as a further example of the process flow 200. For example, the U2U relay UE 404 may be one of the example devices of the first terminal device 110, the transmitting end UE 402 and the receiving end UE 406 may be example devices of the second terminal device 120 and the third terminal device 130. It is to be understood that these devices are described only for the purpose of illustration without suggesting any limitation as to the scope of the disclosure.

At 405, an U2U relay connection may be established between the transmitting end UE 402 and the receiving end UE 406 via the U2U relay UE 404. At 410, the transmitting end UE 402 may have an identification and relevant QoS profile(s) of end-to-end (E2E) radio bearer (RB). The QoS profiles may comprise an end-to-end (E2E) packet delay budget(s).

At 415, the transmitting end UE 402 may transmit or indicate the identification and the relevant QoS profiles of the E2E RB to the U2U relay UE 404. At 420, upon receiving the identification and the relevant QoS profiles of the E2E RB from the transmitting end UE 402, the U2U relay UE 404 may determine a QoS split configuration for the E2E RB in the U2U relay connection, and the QoS split configuration may comprise a set of ranges. At 425, the U2U relay UE 404 may then transmit the QoS split configuration for the E2E RB to the transmitting end UE 402.

At 430, upon receiving the QoS split configuration from the U2U relay UE 404, the transmitting end UE 402 may determine that an expected packet delay over a hop between the U2U relay UE 404 and the transmitting end UE 402 is in an indication of a range [i] among the set of ranges. At 435, the transmitting end UE 402 may then transmit the indication of the range [i] to the U2U relay UE 404.

The step 430 and step 435 may be also initiated from the U2U relay UE 404 to the receiving end UE 406 (or its neighboring U2U relay UE(s) in the case of multi-hop U2U relay) for determining and indicating the range of measured packet delay at the next hop. The receiving end UE 406 may then dynamically adjust the per-hop PDB for the first hop as in step 440. Accordingly, a need to reconfigure QoS split may be avoided as long as the relay connection and QoS profile is kept unchanged.

The adaptation is simple and may be scalable to support multi-hop U2U relay. It may happen that a packet may still be relayed even when E2E PDB of the packet is exceeded. There may be a situation that both of the hops in the two-hop case or multiple consecutive hops in the multi-hop case are in bad conditions and E2E PDB may not be met. Such a situation may be coped with best efforts at each transmittingUE of U2U relay connection.

Alternatively, or additionally, some predefined subset of ranges among the set of ranges indicating that the range in the predefined subset may be optional, such as the range 2 described in FIG. 3, unless upon a transition from the previously indicated range outside the subset to a range inside such as from range 1 to range 2 as described in FIG. 3. For example, according to the embodiments of FIG. 3, at step 435, the transmitting end UE 402 may indicate range 1. When the transmitting end UE 402 determines the expected packet delay over the first hop returns to range 2 at step 430, the transmitting end UE 402 may indicate range 2 to the U2U relay UE 404.

At 440, upon receiving the indication of the range [i] of the hop between the transmitting end UE 402 and the U2U relay UE 404, the U2U relay UE 404 may adjust PDB for a hop between the U2U relay UE 404 and the receiving end UE 406.

In a multi-hop U2U relay scenario, the number of hops between the transmitting end UE 402 and the receiving end UE 406 may be communicated to all the U2U relay UE 404 during or after the E2E multi-hop relay connection establishment. The U2U relay UEs may use this information in step 420 to determine the per-hop PDB. Alternatively, or additionally, the transmitting end UE 402 may calculate the per-hop PDB and communicate this information to the U2U relay UEs during the process of performing step 415.

In the multi-hop U2U relay scenario, the U2U relay UE 404 may also indicate the range on its egress hop to the transmitting end UE 402 or the neighboring U2U relay UE of the ingress hop, in addition to the neighboring U2U relay UE of the egress hop. Accordingly, a U2U relay UE may adjust PDB for its egress hop based on the expected packet delay's ranges on egress hops of its neighbouring UEs, such as the transmitting end UE 402 or other U2U relay UEs.

In the multi-hop U2U relay scenario, the U2U relay UE 404 (as the transmitting UE on its egress hop) may also adjust the packet delay range that the U2U relay UE 404 will indicate to neighbouring U2U relay UE of its egress hop, in addition to adjust PDB for the egress hop as illustrated in step 440. The adjustment of packet delay range may be based on the indicated range received from the transmitting end UE 402 or neighbouring U2U relay UE of its ingress hop at step 435. For instance, if transmitting end UE 402 or neighbouring U2U relay UE indicates range 1 while the U2U relay UE in question estimates the expected packet delay range on egress hop is range 2, the range indicated to the neighbouring U2U relay UE of egress hop may be adjusted to range 1 as the low packet delay in earlier hop may relax the PDB of next hops if the current hop doesn't consume more packet delay.

In some embodiments, the U2U relay UE 404 may predict an increase of the PDB of its egress hop (e.g., due to higher channel busy ratio (CBR)) and notify the transmittingUE and/or other UEs in the multi-hop U2U relay of the predicted PDB range. Additionally, the U2U relay UE 404 may indicate the range of the adjusted PDB on the second hop to the transmitting end UE 402. When steps 420 and 425 are performed once and the reconfiguration of QoS split may be avoided.

The setting of ranges may allow minimizing per-hop packet dropping because the maximum per-hop packet delay or the threshold 3 in the example described above may be set to the maximum limit of the E2E PDB. In the multi-hop U2U relay scenario, threshold 3 may be set to a multiple of E2E PDB divided by the number of hops.

In some embodiments, the step 435 may indicate the value of the measured packet delay in addition to or instead of the range, while the range may be used to trigger the transmission of step 435. This process may allow a tighter adjustment of per-hop PDB. In some embodiments, a base station (BS) or a network function, such as Policy Control Function (PCF), may provide one or more (e.g., a list) PDB split configurations to the UEs 402-406.

In some embodiments, different PDB split configurations (i.e., different ranges, thresholds) may be allocated for different types of services or relay types or bearer types. For example, a PDB split configuration #1 may be allocated for Service ID #1 and a PDB split configuration #2 may be allocated for Service ID #2. With the establishment or update of the U2U relay connection (with two or more hops), the PDB split configuration(s) could be exchanged among involved entities.

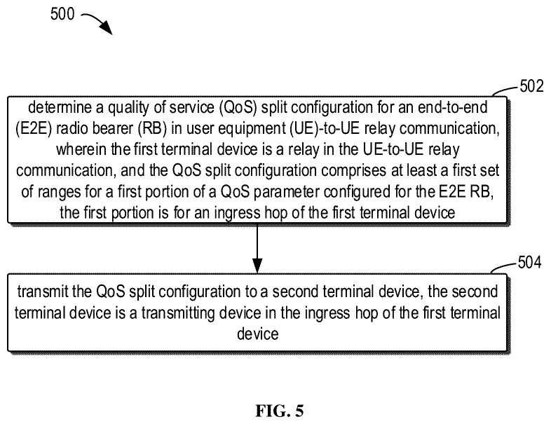

FIG. 5 illustrates a flowchart of a method 500 performed by a terminal device in accordance with some example embodiments of the present disclosure. For the purpose of discussion, the method 500 will be described from the perspective of the first terminal device 110 with reference to FIG. 1. The method 500 includes operations 502 and 504.

At operation 502, the first terminal device 110 may determine a quality of service (QoS) split configuration for an end-to-end (E2E) radio bearer (RB) in user equipment (UE)-to-UE relay communication, wherein the first terminal device 110 is a relay in the UE-to-UE relay communication, and the QoS split configuration comprises at least a first set of ranges for a first portion of a QoS parameter configured for the E2E RB, the first portion is for an ingress hop of the first terminal device 110.

At operation 504, the first terminal device 110 may transmit the QoS split configuration to a second terminal device 120, the second terminal device 120 is a transmitting device in the ingress hop of the first terminal device 110.

In some example embodiments, the terminal device 110 may receive, from the second terminal device 120, a first indication of a range among the first set of ranges for the first portion of the QoS parameter. The first indication of the range among the first set of ranges comprises at least one of an index of the range or a measurement of the first portion of the QoS parameter within the range. The first indication of the range among the first set of ranges may be received via a sidelink (SL) medium access control (MAC) control element (CE).

The first terminal device 110 may adjust, based on the first indication of the range among the first set of ranges received from the second terminal device 120, a second portion of the QoS parameter for an egress hop of the first terminal device 110.

In some embodiments, the first terminal device 110 may determine the QoS split configuration by obtaining information indicative of the number of hop(s) of the UE-to-UE relay communication during or after an establishment procedure of the UE-to-UE relay communication, and determining, based on the number of hop(s), the first portion of the QoS parameter for the ingress hop of the first terminal device 110 to be included in the QoS split configuration.

In some embodiments, the first terminal device 110 may determine, in case the UE-to-UE relay communication is a two-hop relay communication, a second QoS split configuration for the E2E RB in the UE-to-UE relay communication, wherein the second QoS split configuration comprises at least a second set of ranges for the second portion of the QoS parameter for the egress hop of the first terminal device 110.

Alternatively, or additionally, the first terminal device 110 may receive, from a third terminal device 130 in case UE-to-UE relay communication is a multi-hop relay communication, a second QoS split configuration for the E2E RB in the UE-to-UE relay communication, wherein the third terminal device 130 is a relay in the UE-to-UE relay communication and is a receiving device in the egress hop of the first terminal device, and the second QoS split configuration comprises at least a second set of ranges for the second portion of the QoS parameter for the egress hop of the first terminal device 110.

In some embodiments, the first terminal device 110 may determine, among the second set of ranges, a range for the second portion of the QoS parameter for the egress hop of the first terminal device 110. The first terminal device 110 may then transmit, to the third terminal device 130, a second indication of the range among the second set of ranges. In some embodiments, the first terminal device 110 may transmit the second indication to the second terminal device 120.

In some embodiments, the range among the second set of ranges for the second portion of the QoS parameter may be further determined based on the first indication received from the second terminal device 120. In some embodiments, the first terminal device 110 may transmit the second QoS split configuration to the second terminal device 120.

In some embodiments, the first terminal device 110 may determine the QoS split configuration by selecting one of a plurality of QoS split configurations which are configured by a network device for the UE-to-UE relay communication. The second terminal device 120 may be an end UE or a relay in the UE-to-UE relay communication.

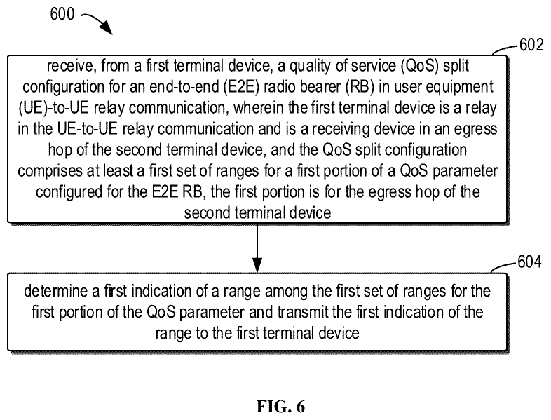

FIG. 6 illustrates a flowchart of a method 600 performed by a terminal device in accordance with some example embodiments of the present disclosure. For the purpose of discussion, the method 600 will be described from the perspective of the second terminal device 120 with reference to FIG. 1. The method 600 includes operations 602 and 604.

At operation 602, the second terminal device 120 may receive, from a first terminal device 110, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device 120, and the QoS split configuration comprises at least a first set of ranges for a first portion of a QoS parameter configured for the E2E RB, the first portion is for the egress hop of the second terminal device 120.

At operation 604, the second terminal device 120 may determine a first indication of a range among the first set of ranges for the first portion of the QoS parameter and transmit the first indication of the range to the first terminal device 110. In some embodiments, the first indication of the range among the first set of ranges comprises at least one of an index of the range or a measurement of the first portion of the QoS parameter within the range.

In some embodiments, the first indication of the range among the first set of ranges is transmitted by the second terminal device 120 via a sidelink (SL) medium access control (MAC) control element (CE). In some embodiments, the second terminal device 120 may receive, from the first terminal device 110, a second QoS split configuration for the E2E RB in the UE-to-UE relay communication, the second QoS split configuration comprises at least a second set of ranges for a second portion of the QoS parameter for an egress hop of the first terminal device 110.

In some embodiments, the second terminal device 120 may receive, from the first terminal device 110, a second indication of a range among the second set of ranges for the second portion of the QoS parameter. The second terminal device 120 may adjust, based on the second indication, the first portion of the QoS parameter for the egress hop of the second terminal device 120. The second terminal device 120 may be an end UE in the UE-to-UE relay communication.

In some embodiments, an apparatus capable of performing the method 500 (for example, the first terminal device 110) may comprise means for performing the respective steps of the method 500. The means may be implemented in any suitable form. For example, the means may be implemented in a circuitry or software module.

In some embodiments, the apparatus comprises means for determining, at a first terminal device, a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device. The apparatus comprises means for transmitting the QoS split configuration to a second terminal device, the second terminal device is a transmitting device in the ingress hop of the first terminal device.

In some example embodiments, the apparatus comprises means for receiving, from the second terminal device, a first indication of a range among the first set of ranges for the first portion of the QoS parameter. The first indication of the range among the first set of ranges comprises at least one of an index of the range or a measurement of the first portion of the QoS parameter within the range. In some example embodiments, the apparatus comprises means for receiving the first indication of the range among the first set of ranges via a sidelink (SL) medium access control (MAC) control element (CE).

In some example embodiments, the apparatus comprises means for adjusting, based on the first indication of the range among the first set of ranges received from the second terminal device, a second portion of the QoS parameter for an egress hop of the first terminal device. In some example embodiments, the apparatus comprises means for determining the QoS split configuration by obtaining information indicative of the number of hop(s) of the UE-to-UE relay communication during or after an establishment procedure of the UE-to-UE relay communication, and determining, based on the number of hop(s), the first portion of the QoS parameter for the ingress hop of the first terminal device to be included in the QoS split configuration.

In some example embodiments, the apparatus comprises means for determining, in case the UE-to-UE relay communication is a two-hop relay communication, a second QoS split configuration for the E2E RB in the UE-to-UE relay communication, wherein the second QoS split configuration comprises at least a second set of ranges for the second portion of the QoS parameter for the egress hop of the first terminal device.

In some example embodiments, the apparatus comprises means for receiving, from a third terminal device in case UE-to-UE relay communication is multi-hop relay communication, a second QoS split configuration for the E2E RB in the UE-to-UE relay communication, wherein the third terminal device is a relay in the UE-to-UE relay communication and is a receiving device in the egress hop of the first terminal device, and the second QoS split configuration comprises at least a second set of ranges for the second portion of the QoS parameter for the egress hop of the first terminal device.

In some example embodiments, the apparatus comprises means for determining, among the second set of ranges, a range for the second portion of the QoS parameter for the egress hop of the first terminal device. In some example embodiments, the apparatus comprises means for transmitting, to the third terminal device, a second indication of the range among the second set of ranges. In some example embodiments, the apparatus comprises means for transmitting the second indication to the second terminal device.

In some embodiments, the range among the second set of ranges for the second portion of the QoS parameter may be further determined based on the first indication received from the second terminal device. In some example embodiments, the apparatus comprises means for transmitting the second QoS split configuration to the second terminal device.

In some example embodiments, the apparatus comprises means for determining the QoS split configuration by selecting one of a plurality of QoS split configurations which are configured by a network device for the UE-to-UE relay communication. The second terminal device may be an end UE or a relay in the UE-to-UE relay communication.

In some example embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing the method 600 (for example, the second terminal device 120) may comprise means for performing the respective steps of the method 600. The means may be implemented in any suitable form. For example, the means may be implemented in a circuitry or software module.

In some example embodiments, the apparatus comprises means for receiving, from a first terminal device, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of a second terminal device.

In some example embodiments, the apparatus comprises means for determining a first indication of a range among the first set of ranges for the first portion of the QoS parameter. In some example embodiments, the apparatus comprises means for transmitting the first indication of the range to the first terminal device. In some embodiments, the first indication of the range among the first set of ranges comprises at least one of an index of the range or a measurement of the first portion of the QoS parameter within the range.

In some example embodiments, the apparatus comprises means for transmitting the first indication of the range among the first set of ranges via a sidelink (SL) medium access control (MAC) control element (CE). In some example embodiments, the apparatus comprises means for receiving, from the first terminal device, a second QoS split configuration for the E2E RB in the UE-to-UE relay communication, the second QoS split configuration comprises at least a second set of ranges for a second portion of the QoS parameter for an egress hop of the first terminal device.

In some example embodiments, the apparatus comprises means for receiving, from the first terminal device, a second indication of a range among the second set of ranges for the second portion of the QoS parameter. In some example embodiments, the apparatus comprises means for adjusting, based on the second indication, the first portion of the QoS parameter for the egress hop of the apparatus. The apparatus may be an end UE in the UE-to-UE relay communication.

In some example embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

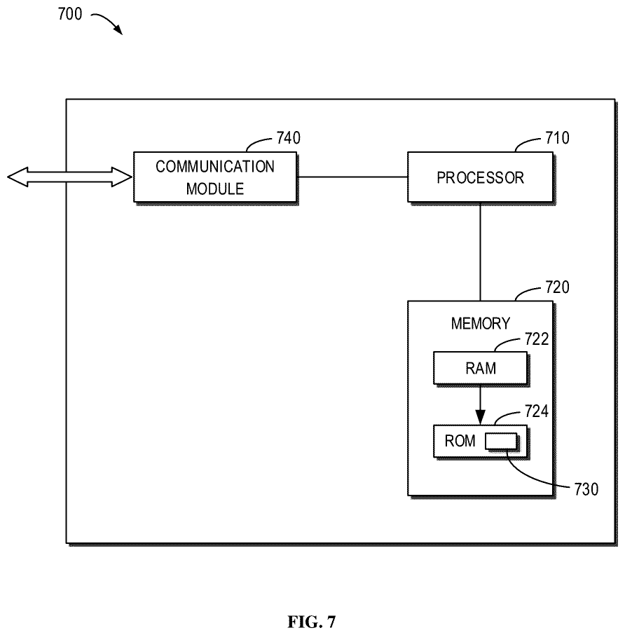

FIG. 7 illustrates a simplified block diagram of a device 700 that is suitable for implementing some example embodiments of the present disclosure. The device 700 may be provided to implement a communication device, for example, the first terminal devices 110 and the second terminal device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

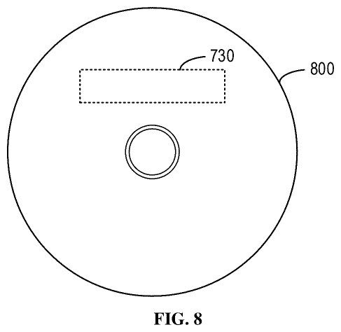

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 830.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-25. (canceled)

26. A first terminal device comprising:
at least one processor; and
at least one memory storing instructions that, when executed by the at least one processor, cause the first terminal device at least to:
determine a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device; and
transmit the QoS split configuration to a second terminal device, the second terminal device is a transmitting device in the ingress hop of the first terminal device.

27. The first terminal device of claim 26, wherein the first terminal device is further caused to:
receive, from the second terminal device, a first indication of a range among the first set of ranges for the first portion of the QoS parameter.

28. The first terminal device of claim 26, wherein the first indication of the range among the first set of ranges comprises at least one of an index of the range or a measurement of the first portion of the QoS parameter within the range.

29. The first terminal device of claim 27, wherein the first indication of the range among the first set of ranges is received via a sidelink (SL) medium access control (MAC) control element (CE).

30. The first terminal device of claim 27, wherein the first terminal device is further caused to:
adjust, based on the first indication of the range among the first set of ranges received from the second terminal device, a second portion of the QoS parameter for an egress hop of the first terminal device.

31. The first terminal device of claim 26, wherein the first terminal device is caused to determine the QoS split configuration by:
obtaining information indicative of the number of hop(s) of the UE-to-UE relay communication during or after an establishment procedure of the UE-to-UE relay communication; and
determining, based on the number of hop(s), the first portion of the QoS parameter for the ingress hop of the first terminal device to be included in the QoS split configuration.

32. The first terminal device of claim 26, the first terminal device is further caused to either:
determine, in case the UE-to-UE relay communication is a two-hop relay communication, a second QoS split configuration for the E2E RB in the UE-to-UE relay communication, wherein the second QoS split configuration comprises at least a second set of ranges for the second portion of the QoS parameter for the egress hop of the first terminal device; or
receive, from a third terminal device in case UE-to-UE relay communication is a multi-hop relay communication, a second QoS split configuration for the E2E RB in the UE-to-UE relay communication, wherein the third terminal device is a relay in the UE-to-UE relay communication and is a receiving device in the egress hop of the first terminal device, and the second QoS split configuration comprises at least a second set of ranges for the second portion of the QoS parameter for the egress hop of the first terminal device.

33. The first terminal device of claim 26, the first terminal device is further caused to:
determine, among the second set of ranges, a range for the second portion of the QoS parameter for the egress hop of the first terminal device; and
transmit, to the third terminal device, a second indication of the range among the second set of ranges.

34. The first terminal device of claim 26, wherein the first terminal device is further caused to:
transmit, to the second terminal device, the second indication.

35. The first terminal device of claim 32, wherein the range among the second set of ranges for the second portion of the QoS parameter is further determined based on the first indication received from the second terminal device.

36. The first terminal device of claim 26, wherein the first terminal device is further caused to:
transmit the second QoS split configuration to the second terminal device.

37. The first terminal device of claim 26, wherein the first terminal device is caused to determine the QoS split configuration by:
selecting one of a plurality of QoS split configurations which are configured by a network device for the UE-to-UE relay communication.

38. The first terminal device of claim 26, wherein the second terminal device is an end UE or a relay in the UE-to-UE relay communication.

39. A second terminal device comprising:
at least one processor; and
at least one memory storing instructions that, when executed by the at least one processor, cause the second terminal device at least to:
receive, from a first terminal device, a quality of service (QOS) split configuration for an end-to-end (E2E) radio bearer (RB) in user equipment (UE)-to-UE relay communication, wherein the first terminal device is a relay in the UE-to-UE relay communication and is a receiving device in an egress hop of the second terminal device, and the QoS split configuration comprises at least a first set of ranges for a first portion of a QoS parameter configured for the E2E RB, the first portion is for the egress hop of the second terminal device; and
determine a first indication of a range among the first set of ranges for the first portion of the QoS parameter.

40. The second terminal device of claim 39, wherein the second terminal device is further caused to:
transmit the first indication of the range to the first terminal device.

41. The second terminal device of claim 39, wherein the first indication of the range among the first set of ranges comprises at least one of an index of the range or a measurement of the first portion of the QoS parameter within the range

42. The second terminal device of claim 39, wherein the first indication of the range among the first set of ranges is transmitted via a sidelink (SL) medium access control (MAC) control element (CE).

43. The second terminal device of claim 39, wherein the second terminal device is further caused to:
receive, from the first terminal device, a second QoS split configuration for the E2E RB in the UE-to-UE relay communication, the second QoS split configuration comprises at least a second set of ranges for a second portion of the QoS parameter for an egress hop of the first terminal device.

44. The second terminal device of claim 39, wherein the second terminal device is further caused to:
receive, from the first terminal device, a second indication of a range among the second set of ranges for the second portion of the QoS parameter; and
adjust, based on the second indication, the first portion of the QoS parameter for the egress hop of the second terminal device.

45. An apparatus comprising:
means for determining, at a first terminal device, a quality of service (QOS) split configuration for an end-to-end (E2E) radio bearer (RB) in user equipment (UE)-to-UE relay communication, wherein the first terminal device is a relay in the UE-to-UE relay communication, and the QoS split configuration comprises at least a first set of ranges for a first portion of a QoS parameter configured for the E2E RB, the first portion is for an ingress hop of the first terminal device; and
means for transmitting the QoS split configuration to a second terminal device, the second terminal device is a transmitting device in the ingress hop of the first terminal device.
